(19) United States
(12) Patent Application Publication
(10) Pub. No.: US 2007/0007815 A1
(43) Pub. Date: Jan. 11, 2007

(54) Wheel set

(76) Inventor: Ting-Hsing Chen, Tainan Hsien (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/172,803

(22) Filed: Jul. 5, 2005

(51) Int. Cl. B60B 11/00

(52) U.S. Cl. 301/36.1

(57) ABSTRACT

A wheel set includes a primary wheel and two secondary wheels. The secondary wheels are disposed at two sides of the primary wheel, respectively. The primary wheel is provided with circular pivoting members at two sides of the primary wheel. Each secondary wheel is provided with a corresponding circular pivoting member to be pivotally connected to the primary wheel. When taking a turn, the primary wheel and the secondary wheels are separately turned to achieve a smooth turn.

### BACKGROUND OF THE INVENTION

(a) Field of the Invention

The present invention relates to a wheel set applied to toy cars, scooters, skateboards, roller skates, tricycles, bikes, and luggage casters, and more particularly, to one that has a primary wheel and secondary wheels disposed at two sides of the primary wheel. When taking a turn, the primary wheel and the secondary wheels are separately turned to achieve a smooth turn.

(b) Description of the Prior Art

A plurality of wheels is usually mounted to toy car, folding scooter, skating board, in-line skate, tricycle, and bike for children as well as luggage trolley. However, any of those children vehicles is generally smaller in size thus to be vulnerable to turn over when taking a turn presenting more dangers particularly to children who are comparatively poor in operating the toy vehicle.

To make it safer to ride, taking the bike exclusively design for children to learn riding a bike as example, one auxiliary wheel smaller than the rear wheel is each eccentrically provided at both sides of the rear wheel to support the rear wheel for avoiding overturn when taking a turn. However, the adaptation of the auxiliary wheels not only increases production and assembly costs, but also requires more time consumed in assembly because additional members are needed. Furthermore, the bike provided with auxiliary wheels produces high noise level and is prevented from easy maintenance.

A latest improvement teaches that the primary wheel is integrated with the auxiliary wheels provided at two sides of the primary wheel. The diameter of the secondary wheel is the same as or smaller than that of the primary wheel. However, the turning is made awkward since all wheels turn together as one piece at the same time.

### SUMMARY OF THE INVENTION

The primary purpose of the present invention is to provide a wheel set composed of a primary wheel and secondary wheels to achieve a smooth turn since the primary wheel and the secondary wheels are separately turned when taking a turn.

To achieve the purpose, the present invention includes a primary wheel and two secondary wheels disposed at two sides of the primary wheel. The primary wheel is provided with circular pivoting members at the two sides of the primary wheel, and each of the secondary wheels is provided with a corresponding circular pivoting member to be pivotally connected to the primary wheel.

The circular pivoting members of the primary wheel are circular pivoting holes, and the circular pivoting member of each secondary wheel is a circular pivoting tube.

The circular pivoting members of the primary wheel are circular pivoting tubes, and the circular pivoting member of each secondary wheel is a circular pivoting hole.

The outer diameter of the primary wheel is greater than that of the secondary wheel, and the secondary wheel is to be an auxiliary wheel.

The outer diameter of the primary wheel is the same as that of the secondary wheel, and the primary wheel and the secondary wheels are to form multiple wheels.

The present invention provides the following advantages:

1. When taking a turn, the primary wheel and the secondary wheels are separately turned to achieve a smooth turn.

2. The total production cost is reduced because molds of the primary wheel and the secondary wheel are separately developed; besides, when separately developed, both molds are made smaller and the development of the smaller mold is easier.

### BRIEF DESCRIPTION OF THE DRAWINGS

FIG. 1 is an exploded view of a first preferred embodiment of the preset invention.

FIG. 2 is a sectional view of the first preferred embodiment of the present invention.

FIG. 3 is a sectional view of the first preferred embodiment of the present invention in an operating status.

FIG. 4 is a sectional view of a second preferred embodiment of the present invention.

FIG. 5 is a sectional view of a third preferred embodiment of the present invention.

FIG. 6 is a sectional view of a fourth preferred embodiment of the present invention.

### DETAILED DESCRIPTION OF THE PREFERRED EMBODIMENTS

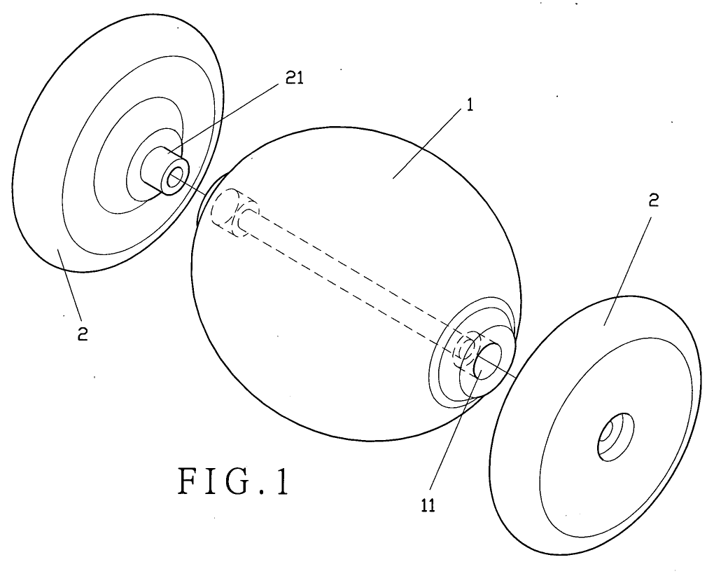

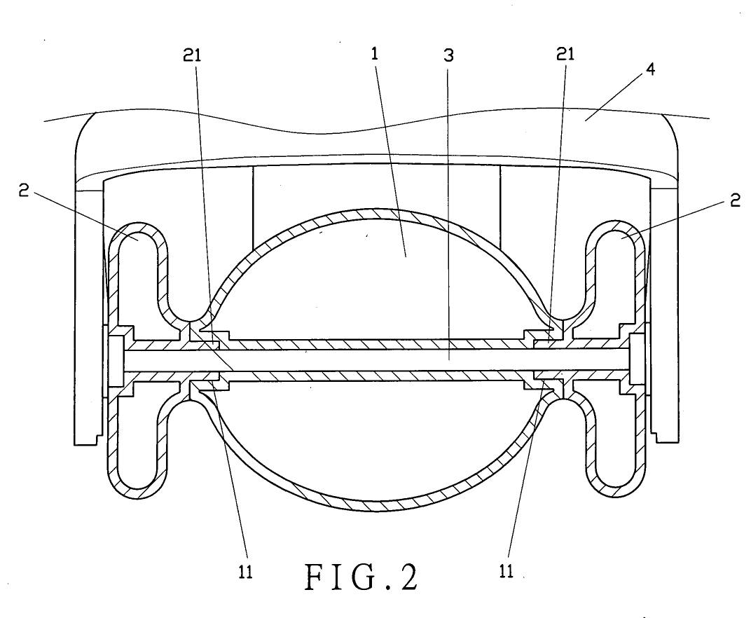

Referring to FIGS. 1 and 2, a first preferred embodiment of the present invention comprises a primary wheel (1) and two secondary wheels (2). The secondary wheels (2) are respectively disposed at two sides of the primary wheel (1).

The primary wheel (1) is provided with circular pivoting members at the two sides. In this preferred embodiment the pivoting members are circular pivoting holes (11). Each secondary wheel (2) is provided with a circular pivoting member corresponding to the circular pivoting members of the primary wheel (1). In this preferred embodiment the pivoting member of each secondary wheel (2) is a circular pivoting tube (21). Thus, the two secondary wheels (2) are pivotally connected to the primary wheel (1) by inserting their respective pivoting tubes (21) into their corresponding pivoting holes (11) of the primary wheel (1).

Molds for the primary wheel (1) and the secondary wheel (2) can be separately developed; and each mold is made smaller for easier development to contribute at the same time so as to reduce the total production cost.

In this preferred embodiment, the outer diameter of each secondary wheel (2) is smaller than that of the primary wheel (1), and each secondary wheel (2) is to be an auxiliary wheel. Upon assembling the wheel set as illustrated in FIG. 2, each secondary wheel (2) has the pivoting tube (21) to be inserted into the pivoting hole (11) of the primary wheel (1), and then the pivoting tube (21) is fixed onto a wheel axle (3). The wheel axle (3) is further to be pivotally connected to a truck (4).

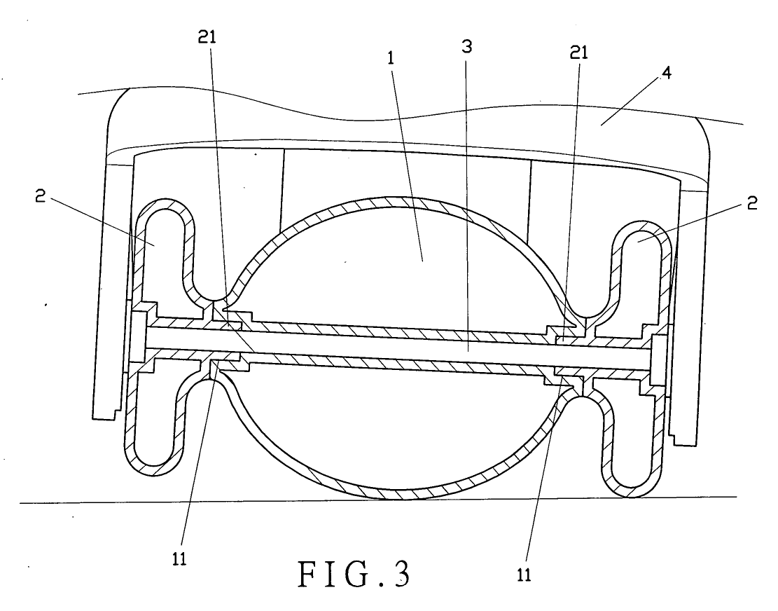

When the wheel set is taking a right (left) turn as illustrated in FIG. 3, the right secondary wheel (2) touches the ground at the same time with the primary wheel (1), thus increasing the contact area with the ground by the primary wheel (1) and the right (left) secondary wheel (2) to achieve a smooth turn.

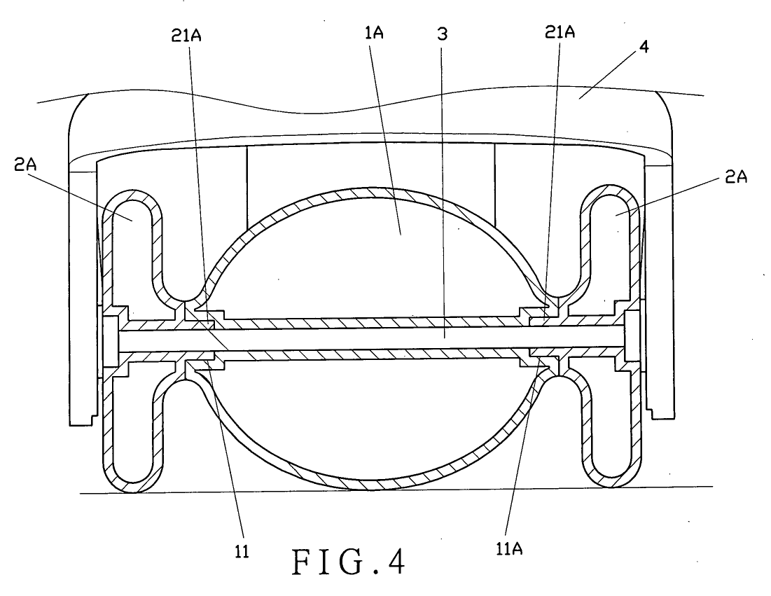

Now referring to FIG. 4 for a second preferred embodiment of the present invention, the wheel set comprises a primary wheel (1A) and two secondary wheels (2A) to form multiple wheels made in the same outer diameter. Wherein, similarly to that of the first preferred embodiment, the pivoting members of the primary wheel (1A) are circular pivoting holes (11A) and the pivoting member of the secondary wheel (2A) is a circular pivoting tube (21A) to be inserted into the pivoting hole (11A). The pivoting tube (21A) of the secondary wheel (2A) is then fixed to the wheel axle (3). The wheel axle (3) is pivotally connected to the truck (4).

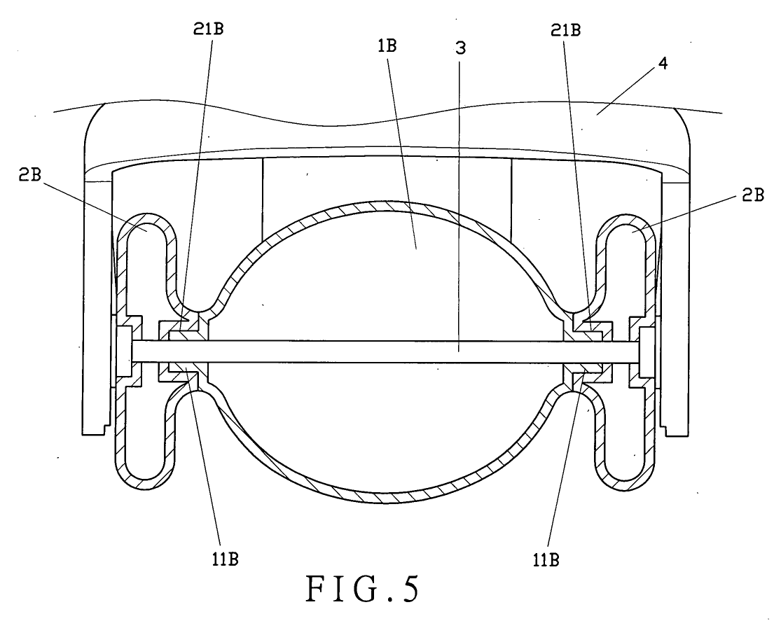

In a third preferred embodiment of the present invention as illustrated in FIG. 5, the outer diameter of a secondary wheel (2B) is smaller than that of a primary wheel (1B). In this preferred embodiment, the pivoting members of the primary wheel (1B) are circular pivoting tubes (11B), and the pivoting member of the secondary wheel (2B) is a circular pivoting hole (21B). The circular pivoting tube (11B) is inserted into the pivoting hole (21B), and then fixed to the wheel axle (3). The wheel axle (3) is pivotally connected to the truck (4).

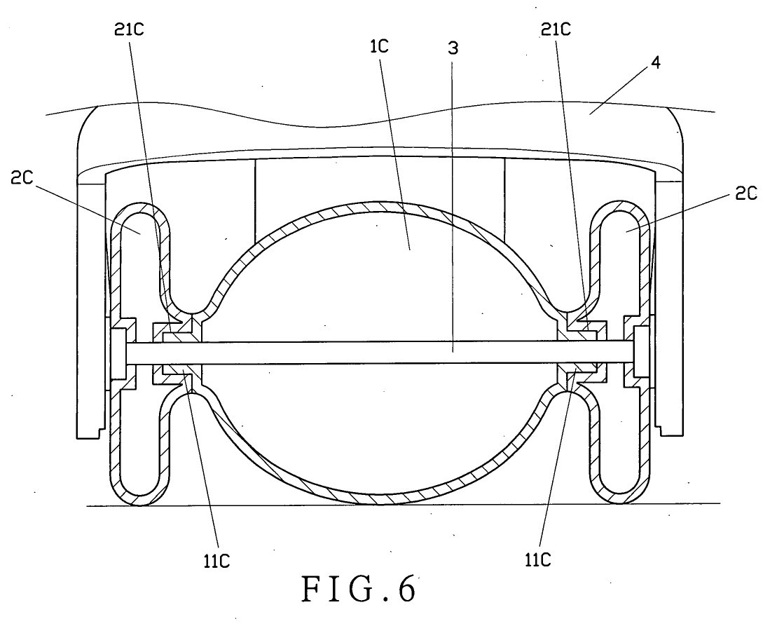

As illustrated in FIG. 6 for a fourth preferred embodiment of the present invention, the outer diameter of a primary wheel (1C) is the same as that of a secondary wheel (2C) thus for the wheel set to be composed of multiple wheels. The pivoting members of the primary wheel (1C) are circular pivoting tubes (11C), and the pivoting member of the secondary wheel (2C) is a circular pivoting hole (21C). The circular pivoting tube (11C) is inserted into the pivoting hole (21C), and then fixed to the wheel axle (3). The wheel axle (3) is pivotally connected to the truck (4).

What is claimed is:

1. A wheel set comprising a primary wheel and two secondary wheels, wherein said secondary wheels are disposed at two sides of said primary wheel, respectively, and characterized by:
said primary wheel comprising circular pivoting members at the two sides of said primary wheel; each of said secondary wheels comprising a corresponding circular pivoting member, said secondary wheels being pivotally connected to said primary wheel.

2. The wheel set of claim 1, wherein said circular pivoting members of said primary wheel are circular pivoting holes, and said pivoting member of each of said secondary wheels is a circular pivoting tube.

3. The wheel set of claim 1, wherein said pivoting members of said primary wheel are circular pivoting tubes, and said pivoting member of each of said secondary wheels is a circular pivoting hole.

4. The wheel set of claim 1, wherein each of said secondary wheels has an outer diameter smaller than that of said primary wheel to be an auxiliary wheel.

5. The wheel set of claim 1, wherein said primary wheel and said secondary wheels have the same outer diameter to form multiple wheels.
